(19) United States
(12) Patent Application Publication
(10) Pub. No.: US 2017/0278176 A1
(43) Pub. Date: Sep. 28, 2017

(54) APPARATUS AND METHOD FOR ORDER FULFILLMENT WITH PORTABLE ITEM CONTAINERS

(71) Applicant: Wal-Mart Stores, Inc., Bentonville, AR (US)

(72) Inventors: Anton Valkov, San Francisco, CA (US); Donald R. High, Noel, MO (US)

(21) Appl. No.: 15/467,172

(22) Filed: Mar. 23, 2017

Related U.S. Application Data
(60) Provisional application No. 62/312,322, filed on Mar. 23, 2016.

(51) Int. Cl. G06Q 30/06; B65B 35/10; B65B 57/00; G06Q 10/08

(52) U.S. Cl. CPC G06Q 30/0635; G06Q 10/083; B65B 35/10; B65B 57/00

(57) ABSTRACT

Systems, apparatuses, and methods are provided herein for order fulfillment. A system for order fulfillment comprises: an item container receiver configured to receive a portable item container configured to hold a plurality of items during transport, a release actuator configured to actuate a switch on the portable item container to cause one unit of an item to be released from the portable item container, and a control circuit coupled to the release actuator and configured to selectively activate the release actuator based an order listing a plurality of ordered items in an order database of a fulfillment center to cause an item among the plurality of items to be released from the portable item container for order fulfillment.

### CROSS-REFERENCE TO RELATED APPLICATION

This application claims the benefit of the following U.S. Provisional Application No. 62/312,322 filed Mar. 23, 2016, which is incorporated herein by reference in its entirety.

### TECHNICAL FIELD

This invention relates generally to order fulfillment facilities.

### BACKGROUND

With the increasing popularity of online shopping and home delivery services, order fulfillment centers have been set up as facilities for storing, picking, and packaging merchandise for deliveries. Conventional fulfillment centers employ “pickers” for gathering merchandise throughout the facilities to fulfill orders.

### BRIEF DESCRIPTION OF THE DRAWINGS

Disclosed herein are embodiments of apparatuses and methods for providing order fulfillment. This description includes drawings, wherein:

FIG. 1 is a block diagram of a system in accordance with several embodiments.

FIG. 2 is a flow diagram of a method in accordance with several embodiments.

FIG. 3 is an illustration of a process in accordance with several embodiments.

Elements in the figures are illustrated for simplicity and clarity and have not necessarily been drawn to scale. For example, the dimensions and/or relative positioning of some of the elements in the figures may be exaggerated relative to other elements to help improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for order fulfillment. A system for order fulfillment comprises an item container receiver configured to receive a portable item container configured to hold a plurality of items during transport, a release actuator configured to actuate a switch on the portable item container to cause one unit of an item to be released from the portable item container, and a control circuit coupled to the release actuator and configured to selectively activate the release actuator based an order listing a plurality of ordered items in an order database of a fulfillment center to cause an item among the plurality of items to be released from the portable item container for order fulfillment.

In some embodiments, a product dispensing system is provided for enhancing the picking and consolidating of products that typically make up a large part of the operating cost many conventional fulfillment centers. In some embodiments, the dispensing system may comprise a movable rack controlled by the central computer system that may move dispensers as needed. These dispensers may be of various sizes based on the sizes of products they are designed to hold. In some embodiments, some products (e.g. oversized items) may be consolidated by hand in conjunction with the dispenser system. In some embodiment, a fulfillment system utilizing portable dispensers may provide faster and more accurate consolidation, picking, and tracking of products during the order fulfillment process.

In some embodiments, after the system receives delivery orders from customers, orders may be prioritized based on delivery distances such that the first delivery on the route may be fulfilled last by the system. In some embodiments, the central computer system may align item dispensers based on the prioritization. In some embodiments, item dispensers may be interchangeable based on need and may be autonomously moved around on sliding racks that are loaded from the top. In some embodiments, the dispensers may be configured to enables control of product rotation and may dispense products on a first in first out basis. In some embodiments, dispensers may automatically dispense products onto a conveyor belt that transfers each product into designated totes at the end of the conveyor line. In some embodiments, products may be dispensed in an order determined based on item fragility (e.g. crushable items placed into a container last) and/or packing compatibility (e.g. don't place raw meats with produce, don't put toxic chemicals with edible, etc.). When a product tote is filled with designated items, the tote may be changed out by an associate and moved to a designated truck for delivery.

In some embodiments, once the delivery container for a first order is filled, dispensers not needed for the next order may be retracted and replaced with dispensers containing items in the next order. In some embodiments, when a dispenser's remaining products fall below a specified level, the central computer system may order more of that product and/or a replacement dispenser. In some embodiments, if the supply of product in the dispenser runs out, a store associate may use products off the backroom shelves to fill the dispensers.

In some embodiments, a central computer system may be configured to arrange dispensers based on customer order information, dispense products based on the fragility of items in the order, and track all orderings to enhance service quality.

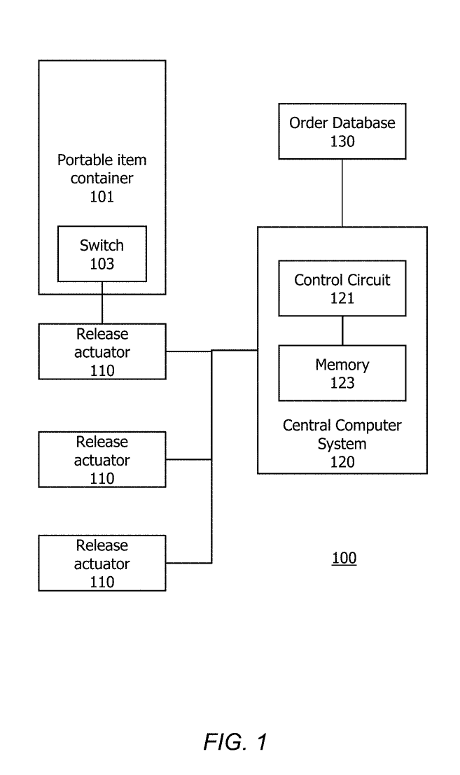

Referring now to FIG. 1, a system for order fulfillment is shown. The system 100 includes a central computer system 120, an order database 130, and a plurality of release actuators 110 coupled to one or more portable item containers 101.

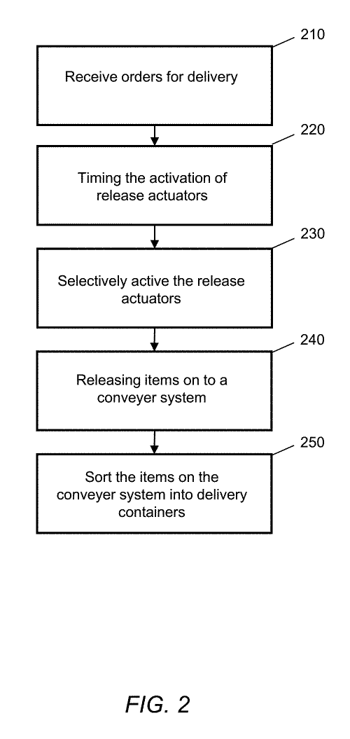

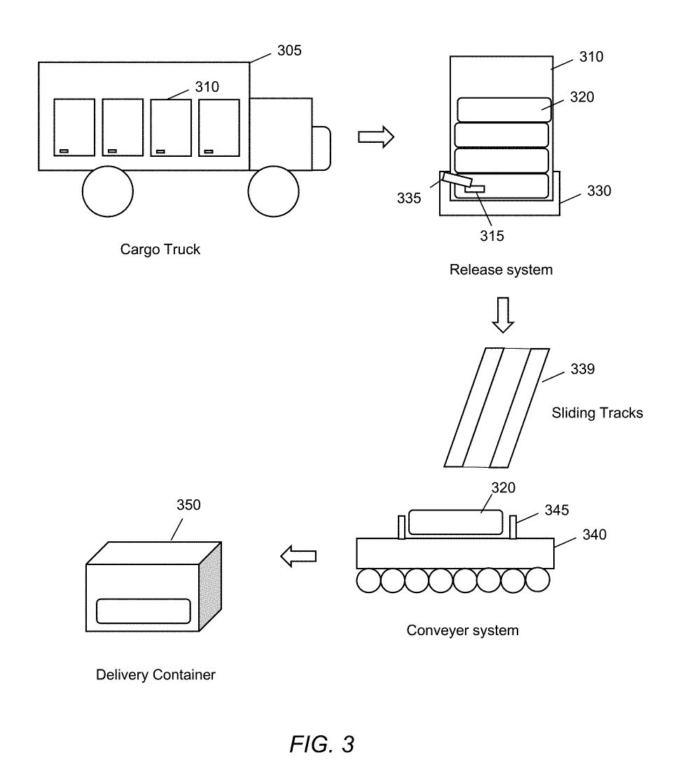

In some embodiments, the system 100 may comprise a system in an order fulfillment center for packing/consolidating items for delivery orders. The central computer system 120 may generally comprise any processor-based device. In some embodiments, the central computer system 120 may comprise one or more of a computer device, a central computer bank, a server, and the like. The central computer system 120 includes a control circuit 121 and a memory 123. The control circuit 121 may comprise a central processing unit, a processor, a microprocessor, and the like. The control circuit 121 may be configured to execute computer readable instructions stored on the computer readable storage memory 123. The computer readable storage memory 123 may comprise volatile and/or non-volatile memory and have stored upon it a set of computer readable instructions which, when executed by the control circuit 121, causes the system to selectively control a plurality of release actuators 110 based at least in part on the information stored in the order database 130. In some embodiments, the memory 123 and/or the order database 130 may further store prioritization rules for determining the order in which the release actuators 110 should be actuated. In some embodiments, the central computer system 120 may further control and/or monitor a conveyor system and a sorter system described with reference to FIGS. 2-3 herein.

The order database 130 may be communicatively coupled to the central computer system 120 and may store a plurality of delivery orders. Delivery orders may generally refer to one or more of: home delivery orders, drone delivery orders, mail delivery orders, online orders, grocery delivery orders, store pickup orders, locker pickup orders, etc. In some embodiments, delivery orders may generally be an order where one or more items are gathers and transferred to a consumer. For each order, the order database 130 may store one or more of a delivery address, a scheduled order date, an expected delivery date, a list of items ordered, quantities of items ordered, etc. associated with the order. In some embodiments, the order database 130 may be coupled to an online shopping user interface through which customers may select items to purchase and enter delivery order information. In some embodiments, the order database 130 may be implemented with the same one or more physical devices as the memory 123 of the central computer system 120. In some embodiments, the order database 130 may be a database accessible by one or more other systems such as an online shopping system, an inventory tracking system, an order tracking system, etc.

The portable item container 101 may comprise a container configured to hold a plurality of items during transport. In some embodiments, the portable item container 101 may be configured to release a unit of its content item with the actuation of the switch 103. In some embodiment, a unit of an item refers to a unit that is intended to be sold separately from other units in the container (e.g. a box, a bag, a bottle, etc.) and may include one or more countable items (e.g. a piece of candy, an apple, etc.). In some embodiments, the containers may be configured to hold any time of item that may be dispensed such one or more of food items, apparel, household items, electronics, stationary, etc. In some embodiments, the portable item container 101 comprises an item release mechanism for controlling the release of the content of the container. The item release mechanism may comprise a mechanical device that causes a unit of an item to drop at a time. In some embodiments, the portable item container 101 may be configured to release items at a bottom of the portable item container. The item release mechanism may vary in design based on the content of the item container. In some embodiments, the item release mechanism may be similar to the release mechanism of one or more of a coin dispenser, a straw dispenser, a candy dispenser, etc. In some embodiments, the release mechanism may rely on gravity to pull units of item towards the opening and allow one unit of the item to be released with each actuation of the switch 103. In some embodiments, an item released from the portable item container 101 through the release mechanism may glide down a sliding track that guides the item towards a conveyor system and/or a delivery container.

In some embodiments, the item container may be configured to hold the plurality of items during transport between one or more of a manufacturer, a distributor, a storage facility, a distribution center, a fulfillment center, etc. In some embodiments, the portable item container 101 may be filled by a manufacturer, supplier, and/or distributor before the container arrives at the distribution center and/or fulfillment center of the system 100. In some embodiments, the portable item container 101 may comprise a reusable container that may be returned to the manufacturer, supplier, and/or distributor after it is emptied at the fulfillment center. In some embodiments, the portable item container 101 may comprise a durable material such as plastic, metal, and composite material. In some embodiments, the portable item container 101 may be standardized and shared among multiple industries, manufactures, and/or supplier, similar to the current industry practices of pallet pooling. In some embodiments, the portable item container 101 may be configured to be transported on one or more transport vehicles without additional packaging (e.g. cardboard boxes). In some embodiments, each of the standardized sizes may correspond to a unit fraction of one or more standardized pallet or skid sizes (e.g. 40 inches by 48 inches in North America, 1000 mm by 1200 mm in Europe and Asia, 42 inches by 42 inches, 36 inches by 36 inches for beverage, etc.). For example, a set number of portable item containers 101 may be sized to occupy a standardized pallet with little or no room to spare on the pallet.

In some embodiments, the form factor of the portable item container 101 may be configured to be placed on/received by an item container receiver of a fulfillment center. The item container receiver may comprise part of a fulfillment center's processing system. In some embodiments, the item container receiver may comprise a platform, a slot, a rack, a stand, etc. In some embodiments, the item container receiver may be configured to hold and support the item container at a higher elevation as compared to one or more of a sliding track, a conveyor system, and delivery containers. In some embodiments, the release actuator 110 may be part of and/or be coupled to the portable item container receiver and may include securing structures for securing the portable item container 101 while items are dispensed. In some embodiments, the item container receiver may further comprise a power port for supplying power to the item release mechanism and/or switch of the portable item container 101. In some embodiments, the portable item container 101 may comprise an opening configured to allow the portable item container 101 to be refilled while the container is on the portable item container receiver.

The switch 103 may comprise a mechanical and/or electrical switch for causing the item release mechanism of the portable item container 101 to operate and release a unit of an item. In some embodiments, the switch may comprise a button, a lever, an electrical contact, etc. In some embodiments, the switch may be recessed relative to the walls of the portable item container 101 to avoid accidental actuation during transport. In some embodiments, the switch may comprise a locking mechanism for preventing accidental actuation during transport. In some embodiments, the switch 103 may be standardized across a plurality of portable item container providers such as manufacturer, supplier, and/or distributor. For example, an item container receiver and a release actuator 110 may be configured to receive and operate the switches 103 on portable item containers 101 from a plurality of providers supplying a variety of different types of items. Generally, the switch may be configured to be electrically and/or mechanically activated by a release actuator 110 of the fulfillment center system.

In some embodiments, the portable item container 101 and/or the item container receiver may further include one or more sensors for monitoring the status of the portable item containers 101 and/or the contents of portable the portable item containers 101. For example, the one or more sensors may be configured to detect one or more of: content level of the portable item container, a jam in the item release mechanism, a misalignment of the portable item container 101 and the portable item the receiver, and a misalignment of the release actuator 110 and the switch 103. In some embodiments, the sensor may notify the central computer system 120 that the portable item container 101 may be emptied and/or nearly emptied and need to be replaced. In some embodiments, the central computer system 120 may track the content level of the portable item container 101 by monitoring how many times the switch has been actuated by a release actuator 110.

The release actuator 110 may comprise an electrical and/or mechanical switch actuator configured to actuate the switch 103 on the portable item container. In some embodiments, the switch 103 may be standardized to one of one or more types of switches and the release actuator 110 may actuate switches on a number of different types of item containers and/or container holding a number of different types of items. In some embodiments, the release actuator 110 may comprise an electrical actuator configured to send a signal to the switch 103 on the portable item container 101 to electrically actuate the switch. In some embodiments, the release actuator 110 may comprise a mechanical actuator configured to contact and actuate the switch 103. While three release actuators 110 are shown in FIG. 1, a fulfillment system may include any number of release actuators 110 each coupled to a different portable item container 101 and controlled by the central computer system 120. In some embodiments, two or more portable item containers 101 may hold and dispense the same type of item such that when one container is emptied, the system can continue to fill orders while the emptied container is replaced and/or refilled.

In some embodiments, the system 100 may further include a conveyor system for receiving items release from portable item containers 101 and routing the items towards delivery containers for delivery. In some embodiments, the conveyor system may comprise one or more slotted conveyor belts. In some embodiments, the control circuit 121 of the central computer system 120 may be configured to time the actuation of the switch based on space availability of the conveyor system. In some embodiments, the central computer system 120 may be configured to time the activation of the release actuator 110 and thereby, the actuation of the switches 103, based on a predetermined loading order of items in one or more orders for delivery. The determination of loading orders is described in more detail with reference to FIG. 2 herein.

Referring now to FIG. 2, a method for order fulfillment is shown. Generally, the method shown in FIG. 2 may be implemented with one or more processor-based devices such as devices having a control circuit, a central processor, a microprocessor, and the like. In some embodiments, each step in the method shown in FIG. 2 may be implemented with the control circuit 111 of the central computer system 120 or a similar computer system.

In some embodiments, priors to step 210 a plurality of portable item containers holding items for sale are received from suppliers (e.g. manufacturers, distributors, etc.). The portable item container may comprise a switch and an item release mechanism. The portable item containers may each be placed on an item container receiver in a fulfillment system and coupled to a release actuator controlled by a central computer system. The central computer system may record the item container/item type associated with each release actuator prior to beginning to fill orders with the item containers.

In step 210, the system receives orders for delivery. In some embodiments, the orders for delivery may be received from an order database of a fulfillment center. Delivery orders may generally comprise one or more of: home delivery orders, drone delivery orders, mail delivery orders, grocery delivery orders, store pickup orders, locker pickup orders, etc. For each order, the order database may store one or more of a delivery address, an order date, an expected delivery date, a list of items ordered, quantities of items ordered, etc. The order database may be coupled to a shopping user interface through which customers may select items to purchase and/or enter delivery order information. In some embodiments, the system and/or a separate shipment management may determine a select subset of orders to be filled by the fulfillment center during a time period. In some embodiments, the subset of orders may correspond to orders selected to be tendered to the same delivery service, delivered by the same delivery vehicle, delivered to a geographic reason, and/or delivered on the same day, etc. In some embodiments, orders may be added to the orders currently being processed and/or fulfilled by a fulfillment center as they are received from customers.

In step 220, the system times the activation of release actuators for actuating switches on a plurality of portable item containers. In some embodiments, timing the activation of the plurality of release actuators may be the based on space availability of a conveyor system for receiving items released from the portable item container.

In some embodiments, timing the activation of the plurality of release actuators may be based on a predetermined loading order of items in one or more orders for delivery. In some embodiments, the system may determine a loading order for one or more delivery containers and one or more items designated for each delivery container. Delivery containers may comprise containers in which items are transferred to customers. For example, a delivery container may comprise one or more of a tote, a cardboard box, a shipping box, etc. shipped to customer's premise with ordered items. Each order may correspond to one or more delivery containers. In some embodiments, an order may be separated into multiple containers if the items in the order exceed the capacity of a single container. In some embodiments, an order may be separated into multiple containers if one or more items are not compatible for sharing a delivery container (e.g. cleaning chemicals and food items).

In some embodiments, the loading orders for the plurality of shopping containers may be determine based on the container's loading order into a delivery vehicle which in turn may be based on the delivery order of the containers on the delivery vehicle's delivery route. In some embodiments, the system or a separate delivery management system may determine delivery routes for one or more delivery vehicles and containers for each delivery trip may be arranged according to their delivery order on the route. In some embodiments, a container scheduled to be delivered first may be placed into the delivery vehicle last such that is readily accessible at the first stop on the delivery route. Similarly, the last container to be delivered on a delivery route may be loaded onto the delivery vehicle first such that it does not obstruct access to other containers. In some embodiments, the loading orders of items in each shopping containers may be determined based on item characteristics such as item fragility. For example, heavy items such as beverages bottles and cans may be loaded first such that the items go to the bottom of the container, while easily damaged items such as bread, chips, some types of produce, may be loaded into to the container last and/or may be placed in separate containers. In some embodiments, each item may be rated on a resilience scale (e.g. sturdy to fragile) in an item database and the items loaded into a container may be assigned a loading order relative to each other based on the scale. In some embodiments, the system may further time the activation of release actuators based on each container's location on the conveyor system. For example, a portable item container further away from the endpoint (e.g. delivery container) of the conveyor system may be actuated at an earlier time to account for the amount of time it takes for the item to travel down the conveyor system. In some embodiments, the switches on the portable item containers may be actuated such that items are arranged on the conveyor system according to predetermined loading order associated with a plurality of delivery containers and/or with items in one or more delivery containers. In some embodiments, step 220 may be optional, and the system may use the conveyor system and/or a sorter system to arrange the items based on loading orders of the items and/or the delivery containers.

In step 230, the system selectively activates the release actuators. In some embodiments, each of the plurality of release actuators may be configured to actuate a switch on a portable item container to cause a unit of an item specified in an order in of the plurality of orders to be released from the portable item container for order fulfillment. In some embodiments, the release actuators may be activated based on the timing and/or loading order determined in step 220. The portable item containers may comprise containers configured hold a plurality of items during transport. In some embodiments, each portable item container may be configured to release a unit of its content item with the actuation of a switch on the container. In some embodiments, the portable item container comprises an item release mechanism for controlling the release of the content of the container. The item release mechanism may comprise a mechanical device that causes a unit of an item to drop at a time. In some embodiments, the item release mechanism may be similar to the release mechanism of one or more of a coin dispenser, a straw dispenser, a candy dispenser, etc. In some embodiments, the release mechanism may rely on gravity to pull units of item towards the opening and allow one unit of the item to be released with each actuation of the switch.

In step 240, an item is released onto a conveyor system. In some embodiments, the portable item container may be positioned above a sliding rack and the item may be released onto the conveyor system via the sliding rack. In some embodiments, a sliding rack may comprise a plurality of dividers with each slot of the rack configured to receive items from a portable item container. In some embodiments, the portable item containers and the sliding racks may be positioned on one or both sides of a conveyor system to drop the released items onto the conveyor system. In some embodiments, the conveyor system may comprise one or more slotted conveyor belts. In some embodiments, the system may be configured to place one item into a slot of the conveyor belt at a time. In some embodiments, the system may be configured to time the actuation of the switch based on space availability of the conveyor system. In some embodiments, the system may time the activation of the plurality of release actuators based on space availability of a conveyor system for receiving items released from the portable item container.

In step 250, items on the conveyor system are sorted into delivery containers. In some embodiments, the conveyor system may comprise one or more segments and branches. One or more item sorter devices may be configured to route one or more items towards one of a plurality of delivery containers going out to customers. In some embodiments, the item sorter may guide and/or push an item from on a part of the conveyor system to another and/or into a delivery container. In some embodiments, the sorter may comprise a conventional sorter used in manufacturing and logistics. In some embodiments, in step 240, the system may record a location of the item on the conveyor system (e.g. slot identifier, convey belt identifier, etc.) and the sorter may sort the items based on their location on the conveyor system (e.g. items in slots 2, 8, and 11 go to container A and items in slots 3, 9, and 14 go to container B, etc.). In some embodiments, the sorter may be configured to read an item identifier (e.g. barcode, RFID tag, etc.) on each item and determine where to route the item based on information in the order database. (e.g. X brand dish soap to container A, Y brand cereal to container B, etc.).

In some embodiments, associates and/or automated motored units may place additional items on the conveyor system. In some embodiments, associates and/or automated movable units may retrieve additional items from storage shelves and/or simple boxes to place on the conveyor system. These items may be similarly moved by the conveyor system, sorted by the sorter system, and routed to designated delivery containers alongside items dispensed from portable item containers with item release mechanisms. In some embodiments, after step 250, the system may generate a notification when each delivery container is filled. An associate and/or an automated device may then load the filled delivery container into a delivery vehicle and/or transfer the containers to a delivery service (e.g. postal service, parcel service, etc.).

In some embodiments, instead of employing an item sorter, a delivery container may be placed directly onto the conveyor system and be filled by the portable item containers while traveling down the conveyor system. In some embodiments, the portable item containers may be arranged in the order of durability/resilience along the conveyor system such that relatively heavier/more durable items are placed into the delivery container earlier and easily damaged items are placed later in the process.

Next referring to FIG. 3, an illustration of an order fulfillment process is shown. In a portable item container order fulfillment process, a portable item container 310 holding a plurality of items 320 are transported to a fulfillment center by a transport vehicle 305 such as a cargo truck, a ship, a train, etc. The portable item container 310 may comprise a dispenser that includes a release mechanism for releasing one unit of an item 320 from the portable item container at a time. At the fulfillment center, the portable item container 310, along with items 320 transported in the portable item container 310, may be placed on a portable item container receiver 330 such that a release actuator 335 of the portable item container receiver 330 is coupled with a release switch 315 for activating the release mechanism of the portable item container 310. In some embodiments, a control circuit may actuate the release switch 315 based on loading orders for one or more delivery containers and one or more items designated for each delivery container. When the release switch 315 is activated, one unit of the item 320 may be released onto a conveyor system 340 via sliding tracks 339. In some embodiments, the sliding track 339 allows the released items 320 to glide down onto a conveyor system that is in motion. In some embodiments, the conveyor system may comprise slot dividers 345 for keeping items that are placed on the conveyor system separated. The conveyor system 340 may then move the item towards a delivery container 350. In some embodiments, the system may include a sorter for routing each item on the conveyor system towards the designated delivery container 350 associated with the item based on orders associated with each delivery container 350. After a delivery container 350 is filled and labeled, the delivery container 350 may be placed on a delivery vehicle and/or transferred to a customer.

In one embodiment, a system for order fulfillment comprises an item container receiver configured to receive a portable item container configured to hold a plurality of items during transport, a release actuator configured to actuate a switch on the portable item container to cause one unit of an item to be released from the portable item container, and a control circuit coupled to the release actuator and configured to selectively activate the release actuator based an order listing a plurality of ordered items in an order database of a fulfillment center to cause an item among the plurality of items to be released from the portable item container for order fulfillment.

In one embodiment, a method for order fulfillment comprises receiving, at a control circuit, a plurality of orders for delivery from an order database of a fulfillment center, and selectively activate, by the control circuit and based on the plurality of orders, a plurality of release actuators each configured to actuate a switch on a portable item container to cause a unit of an item specified in an order in of the plurality of orders to be released from the portable item container for order fulfillment, wherein the portable item container is placed on an item container receiver having a release actuator and configured to hold a plurality of items during transport.

In one embodiment, a system for order fulfillment comprises: a plurality of portable item containers each configured to hold a plurality of items during transport, each portable item container comprises a release mechanism for releasing one item from the portable item container at a time, a plurality release actuators each configured to actuate a switch on a portable item container to actuate the release mechanism in the portable item container, a conveyor system configured to move items to one or more delivery containers, and a control circuit coupled to the plurality of release actuators and configured to selectively activate each of the plurality of the release actuators based on a plurality of orders in an order database of a fulfillment center to cause items specified in the plurality of orders to be released onto the conveyor system for order fulfillment.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for order fulfillment comprising:
an item container receiver configured to receive a portable item container configured to hold a plurality of items during transport;
a release actuator configured to actuate a switch on the portable item container to cause one unit of an item to be released from the portable item container; and
a control circuit coupled to the release actuator and configured to selectively activate the release actuator based an order listing a plurality of ordered items in an order database of a fulfillment center to cause an item among the plurality of items to be released from the portable item container for order fulfillment.

2. The system of claim 1, wherein the portable item container comprises an item release mechanism configured to release one item with each actuation of the switch.

3. The system of claim 1, wherein the portable item container is configured to release items at a bottom of the portable item container.

4. The system of claim 1, wherein the release actuator comprises a mechanical actuator and the switch on the portable item container comprises a mechanical switch.

5. The system of claim 1, wherein the release actuator comprises an electrical actuator configured to send a signal to the switch on the portable item container to electrically actuate the switch.

6. The system of claim 1, wherein the portable item container is configured to hold the plurality of items during transport between one or more of a manufacturer, a distributor, a storage facility, a distribution center, and the fulfillment center.

7. The system of claim 1, wherein the item is released onto a conveyor system that moves the item to a delivery container.

8. The system of claim 7, wherein the item container receiver is configured to position the portable item container above a sliding rack and the item is released to the conveyor system via the sliding rack.

9. The system of claim 7, wherein the control circuit is further configured to time an actuation of the switch based on space availability of the conveyor system.

10. The system of claim 7, wherein the conveyor system comprises a slotted conveyor belt.

11. The system of claim 7, further comprising an item sorter configured to sort items on the conveyor system into a plurality of delivery containers.

12. The system of claim 1, wherein the control circuit is further configured to time an actuation of the switch based on a predetermined loading order of items in the order.

13. The system of claim 1, wherein the item container receiver is configured to receive one or more standardized sizes of portable item containers.

14. The system of claim 13, wherein the one more standardized sizes comprises to one or more of a size of a standardized pallet and a size corresponding to a unit fraction of the size of the standardized pallet.

15. The system of claim 1, wherein the control circuit is configured to activate a plurality of release actuators for actuating switches on a plurality of portable item containers based on a plurality of orders in the order database.

16. A method for order fulfillment comprising:
receiving, at a control circuit, a plurality of orders for delivery from an order database of a fulfillment center; and
selectively activate, by the control circuit and based on the plurality of orders, a plurality of release actuators each configured to actuate a switch on a portable item container to cause a unit of an item specified in an order in of the plurality of orders to be released from the portable item container for order fulfillment;
wherein the portable item container is placed on an item container receiver having a release actuator and configured to hold a plurality of items during transport.

17. The method of claim 16, further comprising: timing an activation of the plurality of release actuators based on space availability of a conveyor system for receiving items released from the portable item container.

18. The method of claim 16, further comprising: timing an activation of the plurality of release actuators based on a predetermined loading order of items in one or more orders for delivery.

19. The method of claim 16, further comprising:
causing the item to be released onto a conveyor system;
storing a location of the item on the conveyor system, and
causing an item sorter to sort the item into a delivery container associated with the order based on the location of the item on the conveyor system.

20. The method of claim 16, further comprising: causing an item sorter to sort the item into a delivery container associated with the order based on reading an item identifier on the item.

21. A system for order fulfillment comprising:
a plurality of portable item containers each configured to hold a plurality of items during transport, each portable item container comprises a release mechanism for releasing one item from the portable item container at a time;
a plurality of release actuators each configured to actuate a switch on one of the plurality of portable item containers to actuate the release mechanism in the portable item container;
a conveyor system configured to move items to one or more delivery containers; and
a control circuit coupled to the plurality of release actuators and configured to selectively activate each of the plurality of release actuators based on a plurality of orders in an order database of a fulfillment center to cause the items specified in the plurality of orders to be released onto the conveyor system for order fulfillment.
